(19) United States
(12) Patent Application Publication
(10) Pub. No.: US 2010/0030469 A1
(43) Pub. Date: Feb. 4, 2010

(54) CONTENTS NAVIGATION APPARATUS AND METHOD THEREOF

(76) Inventors: Kyu-Tae Hwang, Seoul (KR); Suk-Jin Chang, Seongnam (KR); Jong-Rak Lim, Seongnam (KR)

Correspondence Address: BIRCH STEWART KOLASCH & BIRCH, PO BOX 747, FALLS CHURCH, VA, 22040-0747, US

(21) Appl. No.: 12/465,258

(22) Filed: May 13, 2009

(30) Foreign Application Priority Data
Jul. 31, 2008 (KR) 10-2008-0075312

(51) Int. Cl. G01C 21/36

(52) U.S. Cl. 701/209; 701/200; 701/207

(57) ABSTRACT

A contents navigation method including displaying contents on a display screen of a navigation apparatus, sensing, via a sensing unit, a motion of the navigation apparatus, receiving an input signal configured to turn on and off the sensing unit, and controlling, via a controller, the displayed contents according to the sensed motion of the navigation apparatus by the sensing unit when the received input signal turns on the sensing unit.

### CROSS-REFERENCE TO A RELATED APPLICATION

The present application claims priority to Korean Application No. 10-2008-0075312, filed in Korea on Jul. 31, 2008, which is herein expressly incorporated by reference in its entirety.

### BACKGROUND OF THE INVENTION

1. Field of the Invention

The present invention relates to a contents navigation apparatus and corresponding method.

2. Background of the Invention

A contents navigation apparatus serves to execute functions relating to a corresponding content by controlling displayed contents through a user interface (UI) and/or a graphic user interface (GUI). In more detail, navigation apparatus are generally installed in vehicles or included with mobile terminals and allow users to view navigation information (e.g., directions, nearby point of interest, etc.). The navigation apparatus also include complex GUIs that the user must manipulate to retrieve the desired navigation contents. However, the complexity of the GUIs often inconveniences a user, especially when they are driving their vehicle or using a mobile terminal with a small display area.

### SUMMARY OF THE INVENTION

Accordingly, an object of the present invention is to address the above-noted and other problems.

Another object of the present invention is to provide a novel navigation apparatus and corresponding method that displays navigation contents based on a sensed movement of the navigation apparatus.

To achieve these and other advantages and in accordance with the purpose of the present invention, as embodied and broadly described herein, the present invention provides in one aspect a contents navigation method including displaying contents on a display screen of a navigation apparatus, sensing, via a sensing unit, a motion of the navigation apparatus; receiving an input signal configured to turn on and off the sensing unit, and controlling, via a controller, the displayed contents according to the sensed motion of the navigation apparatus by the sensing unit when the received input signal turns on the sensing unit.

In another aspect, the present invention provides a navigation apparatus including a display unit configured to display contents on a display screen of a navigation apparatus, a sensing unit configured to sense a motion of the navigation apparatus, an input unit configured to receive an input signal configured to turn on and off the sensing unit, and a controller configured to control the displayed contents according to the sensed motion of the navigation apparatus by the sensing unit when the received input signal turns on the sensing unit.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of a mobile terminal to which a contents navigation apparatus according to an embodiment of the present invention is applied;

FIG. 2 is a block diagram of a telematics terminal to which a contents navigation apparatus according to an embodiment of the present invention is applied;;

FIG. 3 is a block diagram of a contents navigation apparatus according to an embodiment of the present invention;

FIGS. 4A to 4C are front perspective views of the contents navigation apparatus of FIG. 3;

FIG. 5 is an overview showing directions of a terminal sensed by a sensor unit according to an embodiment of the present invention;

FIGS. 6A to 6D are overviews showing changes of a focus on a content according to an embodiment of the present invention;

FIGS. 7A to 7D are overviews of display screens showing execution of corresponding functions according to changes of a focus according to one example of the present invention;

FIGS. 8A to 8C are overviews of display screens showing execution of corresponding functions according to changes of a focus according to another example of the present invention;

FIG. 9 is a flowchart showing a contents navigation method according to a first embodiment of the present invention;

FIG. 10 is a flowchart showing a contents navigation method according to a second embodiment of the present invention;

FIG. 11 is a flowchart showing a contents navigation method according to a third embodiment of the present invention;

FIG. 12 is a flowchart showing a contents navigation method according to a fourth embodiment of the present invention;

FIG. 13 is a flowchart showing a contents navigation method according to a fifth embodiment of the present invention;

FIG. 14 is a flowchart showing a contents navigation method according to a sixth embodiment of the present invention;

FIGS. 15A to 15E are overviews of display screens showing a contents navigation method according to a seventh embodiment of the present invention; and

FIG. 16 is a flowchart showing a route search method using a contents navigation method according to an eighth embodiment of the present invention.

### DETAILED DESCRIPTION OF THE INVENTION

Hereinafter, preferred embodiments of the present invention will be explained in more detail with reference to the attached drawings. The same or equivalent components will be provided with the same reference numerals, and their detailed explanations will be omitted.

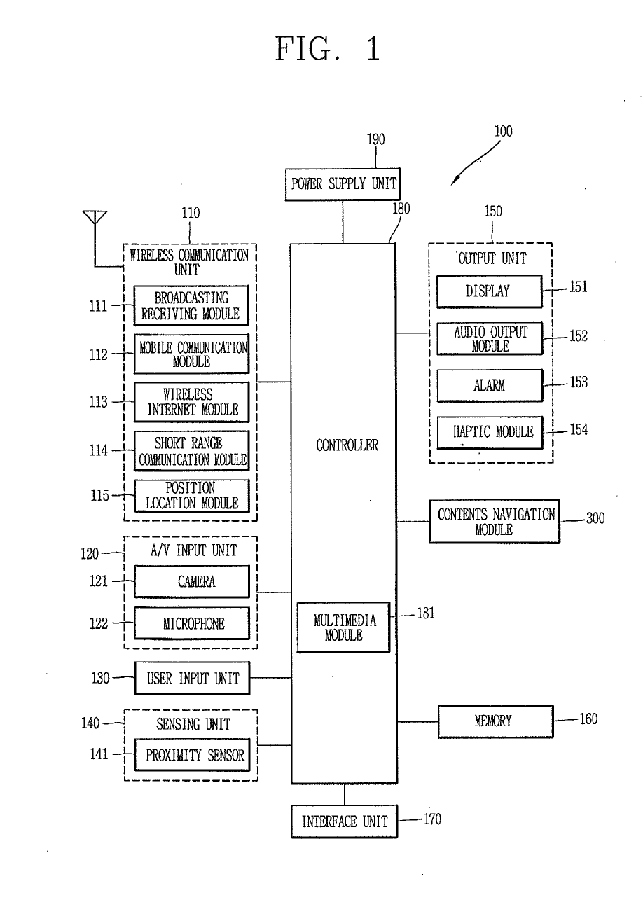

FIG. 1 is a block diagram showing a configuration of a mobile terminal 100 to which a contents navigation module 300 according to an embodiment of the present invention is applied. The mobile terminal 100 may be implemented in various forms. For instance, the mobile terminal 100 may include portable terminals, smart phones, notebook computers, digital multimedia broadcasting terminals, Personal Digital Assistants (PDA), Portable Multimedia Players (PMP), navigations (in-vehicle navigation apparatuses), and the like.

As shown in FIG. 1, the mobile terminal 100 includes a wireless communication unit 110, an A/V (Audio/Video) input unit 120, a user input unit 130, a sensor unit 140, an output unit 150, a memory 160, an interface unit 170, a controller 180, a power supply unit 190, and the like. FIG. 1 shows the mobile terminal 100 having various components, but it should be understood that implementing the mobile terminal 100 with all of the illustrated components is not a requirement. Greater or fewer components may be alternatively implemented.

In addition, the wireless communication unit 110 may include one or more components which permit wireless communications between the mobile terminal 100 and a wireless communication system or between the mobile terminal 100 and a network within which the mobile terminal 100 is located. For example, in FIG. 1, the wireless communication unit 110 includes at least one of a broadcasting receiving module 111, a mobile communication module 112, a wireless internet module 113, a short-range communication module 114, a position location module 115, and the like.

Further, the broadcasting receiving module 111 receives a broadcast signal and/or broadcast associated information from an external broadcast managing server via a broadcast channel. The broadcast channel may include a satellite channel and a terrestrial wave channel. Also, the broadcast managing server may indicate a server which generates and transmits a broadcast signal and/or broadcast associated information or a server which receives a pre-generated broadcast signal and/or broadcast associated information and sends the information to the mobile terminal 100. Examples of broadcast associated information include information associated with a broadcast channel, a broadcast program, a broadcast service provider, and the like. The broadcast signal may be implemented as a TV broadcast signal, a radio broadcast signal, and a data broadcast signal, among others. The broadcast signal may further include a data broadcast signal combined with a TV or radio broadcast signal.

In addition, the broadcast associated information may be provided via a mobile communication network, and received by the mobile communication module 112. The broadcast associated information may be implemented in various formats. For instance, broadcast associated information may include an Electronic Program Guide (EPG) of the Digital Multimedia Broadcasting (DMB) system, an Electronic Service Guide (ESG) of the Digital Video Broadcast-Handheld (DVB-H) system, and the like.

Further, the broadcasting receiving module 111 may be configured to receive digital broadcast signals transmitted from various types of broadcast systems. Such broadcast systems may include the Digital Multimedia Broadcasting-Terrestrial (DMB-T) system, the Digital Multimedia Broadcasting-Satellite (DMB-S) system, the Media Forward Link Only (MediaFLO) system, the Digital Video Broadcast-Handheld (DVB-H) system, the Integrated Services Digital Broadcast-Terrestrial (ISDB-T) system, and the like. The broadcasting receiving module 111 may be configured to be suitable for all kinds of broadcast systems transmitting broadcast signals as well as the digital broadcasting systems. Broadcast signals and/or broadcast associated information received via the broadcasting receiving module 111 may also be stored in a suitable device, such as a memory 160.

In addition, the mobile communication module 112 transmits/receives wireless signals to/from at least one of network entities (e.g., a base station, an external mobile terminal, a server, etc.) on a mobile communication network. The wireless signals may include an audio call signal, a video call signal, and/or various formats of data according to transmission/reception of text/multimedia messages. Also, the wireless internet module 113 supports wireless Internet access for the mobile terminal and may be internally or externally coupled to the mobile terminal 100. Wireless Internet techniques may include Wireless LAN (WLAN) (Wi-Fi), Wireless Broadband (Wibro), World Interoperability for Microwave Access (Wimax), High Speed Downlink Packet Access (HSDPA), and the like.

Also, the short-range communication module 114 denotes a module for short-range communications. Suitable technologies for implementing the short-range communication module 114 may include BLUETOOTH, Radio Frequency IDentification (RFID), Infrared Data Association (IrDA), Ultra-WideBand (UWB), ZigBee, and the like. Further, the position location module 115 denotes a module for detecting or calculating a position of a mobile terminal. An example of the position location module 115 may include a Global Positioning System (GPS) module that receives position information in cooperation with associated multiple satellites. Further, the position information may include coordinates information represented by a latitude and longitude. For example, the GPS module can measure accurate time and distance respectively from more than three GPS satellites so as to accurately calculate a current position of the mobile terminal 100 based on such three different distances according to a triangulation scheme. A scheme may be used to obtain time information and distance information from three GPS satellites and correct an error by one GPS satellite. Specifically, the GPS module can further obtain three-dimensional speed information and an accurate time, as well as position on latitude, longitude and altitude, from the position information received from the GPS satellites. As the position location module 115, a Wi-Fi Positioning System and/or a Hybrid Positioning System may also be used.

In addition, the A/V input unit 120 is configured to provide audio or video signal input to the mobile terminal 100. As shown in FIG. 1, the A/V input unit 120 includes a camera 121 and a microphone 122. The camera 121 receives and processes image frames of still pictures or video obtained by image sensors in a video call mode or a capturing mode. The processed image frames may then be displayed on a display 151. Further, the image frames processed by the camera 121 may be stored in the memory 160 or transmitted to another terminal via the wireless communication unit 110. Two or more cameras 121 may also be provided according to the configuration of the mobile terminal.

Further, the microphone 122 receives an external audio signal while the portable device is in a particular mode, such as a phone call mode, recording mode and voice recognition mode. The received audio signal is then processed and converted into digital data. In the calling mode, the processed voice data is converted and output into a form capable of transmitting it to the mobile communication base station through the mobile communication module 112. Also, the portable device, and in particular the A/V input unit 120, includes assorted noise removing algorithms to remove noise generated in the course of receiving the external audio signal.

The mobile terminal 100 also includes a user input unit 130 that generates input data responsive to user manipulation of an associated input device or devices. Examples of such devices include a keypad, a dome switch, a touchpad (e.g., static pressure/capacitance), a jog wheel and a jog switch. A sensing unit 140 is also included in the mobile terminal 100 and provides status measurements of various aspects of the mobile terminal 100. For instance, the sensor unit 140 may detect an open/close status of the mobile terminal 100, relative positioning of components (e.g., a display and keypad) of the mobile terminal 100, changes of position of the mobile terminal 100 or a component of the mobile terminal 100, presence or absence of user contact with the mobile terminal 100, orientation or acceleration/deceleration of the mobile terminal 100, etc. As an example, when the mobile terminal 100 is a slide-type mobile terminal, the sensing unit 140 may sense whether a sliding portion of the mobile terminal 100 is open or closed. Other examples include the sensing unit 140 sensing the presence or absence of power provided by a power supply 190, the presence or absence of a coupling or other connection between an interface unit 170 and an external device, etc. The sensing unit 140 may also include a proximity sensor 141.

In addition, the output unit 150 is configured to output audio signals, or video signals or alarm signals or tactile-related signals, and may include the display 151, an audio output module 152, an alarm 153, a haptic module 154, and the like. The display 151 is configured to visually display information processed in the mobile terminal 100. For instance, if the mobile terminal 100 is operating in a phone call mode, the display 151 will generally provide a user interface (UI) or graphical user interface (GUI), which includes information associated with placing, conducting, and terminating a phone call. As another example, if the mobile terminal 100 is in a video call mode or a photographing mode, the display 151 may additionally or alternatively display images which are associated with these modes.

Further, the display 151 may be implemented using at least one of display technologies including, for example, a liquid crystal display (LCD), a thin film transistor-liquid crystal display (TFT-LCD), an organic light-emitting diode display (OLED), a flexible display and a three-dimensional display. The display 151 may also be implemented as a transparent type or an optical transparent type through which the exterior is viewable, which is referred to as ‘transparent display’. A representative example of the transparent display may include a Transparent OLED (TOLED), and the like. The display 151 may also be configured such that a rear front is also transparent. Under this configuration, a user can view an object positioned at a rear side of a terminal body through the display 151 of the terminal body.

Also, the display 151 may be implemented in two or more in number according to a configured aspect of the mobile terminal 100. For instance, a plurality of the displays 151 may be arranged on one surface in a spacing manner or in an integrated manner, or may be arranged on different surfaces of the terminal 100. Further, if the display 151 and a touch sensor have a layered structure therebetween, the structure may be referred to as a touch screen. The display 151 may also be used as an input device as well as an output device. The touch sensor may also be implemented as a touch film, a touch sheet, a touch pad, and the like. The touch sensor may be configured to convert changes of a pressure applied to a specific part of the display 151, or a capacitance occurring from a specific part of the display 151, into electric input signals. Also, the touch sensor may be configured to sense not only a touched position and a touched area, but also a touch pressure. When touch inputs are sensed by the touch sensor, corresponding signals are transmitted to a touch controller (not shown). The touch controller then processes the received signals, and transmits corresponding data to the controller 180. Accordingly, the controller 180 may sense which region of the display 151 has been touched.

In addition, the proximity sensor 141 may be arranged at an inner region of the mobile terminal 100 covered by the touch screen, or near the touch screen. The proximity sensor 141 indicates a sensor to sense a presence or absence of an object approaching to a surface to be sensed, or an object disposed near a surface to be sensed by using an electromagnetic field or infrared rays without a mechanical contact. The proximity sensor 141 also has a longer lifespan and a more enhanced utilization degree than a contact sensor.

Further, the proximity sensor 141 may include a transmissive type photoelectric sensor, a direct reflective type photoelectric sensor, a mirror reflective type photoelectric sensor, a high-frequency oscillation type proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this instance, the touch screen (touch sensor) may be categorized as a proximity sensor.

Hereinafter, a status that the pointer is positioned to be proximate onto the touch screen without contact will be referred to as ‘proximity touch’, whereas a status that the pointer substantially comes in contact with the touch screen will be referred to as ‘contact touch’. The pointer in a status of ‘proximity touch’ is positioned so as to be vertical with respect to the touch screen. In addition, the proximity sensor 141 senses a proximity touch, and proximity touch patterns (e.g., distance, direction, speed, time, position, moving status, etc.). Information relating to the sensed proximity touch, and the sensed proximity touch patterns may be output onto the touch screen.

The audio output module 152 may output audio data received from the wireless communication unit 110 or stored in the memory 160, in a call-receiving mode, a call-placing mode, a recording mode, a voice recognition mode, a broadcast reception mode, and so on. The audio output module 152 may also output audio signals relating to functions performed in the mobile terminal 100, e.g., a call signal reception sound, a message reception sound, and so on. The audio output module 152 may include a receiver, a speaker, a buzzer, and so on.

Further, the alarm 153 outputs signals notifying the user about an occurrence of events in the mobile terminal 100. The events occurring in the mobile terminal 100 may include a call signal reception, a message reception, a key signal input, touch input, and so on. The alarm 153 may output not only video or audio signals, but also other types of signals such as signals notifying the user about the occurrence of events in a vibration manner. When call signals or messages are received, the alarm 153 may implement the mobile terminal 100 to vibrate through a vibration mechanism to notify the user about the reception. When key signals are input, the alarm 153 may implement the mobile terminal 100 to vibrate through a vibration mechanism as a feedback to the input. A user can then recognize occurrence of events through the vibration of the mobile terminal 100. Signals notifying the occurrence of events may be output through the display 151 or the audio output module 152. The display 151 and the audio output module 152 may also be categorized into a part of the alarm 153.

In addition, the haptic module 154 generates various tactile effects. A representative example of the tactile effects generated by the haptic module 154 includes vibration. Vibration generated by the haptic module 154 may have a controllable intensity, a controllable pattern, and so on. For instance, a different vibration may be output in a synthesized manner or in a sequential manner. The haptic module 154 may generate various tactile effects including not only vibration, but also arrangement of pins vertically moving with respect to a skin surface contacting the haptic module 154, an air injection force or air suction force through an injection hole or a suction hole, a touch by a skin surface, a presence or absence of contact with an electrode, effects by stimulus such as an electrostatic force, and reproduction of a cold or hot feeling using a heat absorbing device or a heat emitting device. The haptic module 154 may also be configured to transmit tactile effects through a user's direct contact, or a user's muscular sense using a finger or a hand. The haptic module 154 may also be implemented in two or more in number according to a configuration of the mobile terminal 100.

Also, the memory 160 may store programs to operate the controller 180, or may temporarily store input/output data (e.g., music, still images, moving images, map data, and so on). The memory 160 may also store data relating to vibration and sounds of various patterns output when touches are input onto the touch screen. In addition, the memory 160 may be implemented using any type or combination of suitable memory or storage devices including a flash memory type, a hard disk type, a multimedia card micro type, a card type (SD or XD memory), random access memory (RAM), static random access memory (SRAM), electrically erasable programmable read-only memory (EEPROM), programmable read-only memory (PROM), read-only memory (ROM), magnetic memory, magnetic or optical disk, or other similar memory or data storage device. The mobile terminal 100 may also operate a web storage on the Internet, or may be operated in relation to a web storage that performs a storage function of the memory 160.

Further, the interface unit 170 interfaces the mobile terminal 100 with all external devices connected to the mobile terminal 100. For example, the interface 170 may include a wire/wireless headset port, an external charger port, a wire/wireless data port, a memory card port, a port to connect a device having a recognition module to the mobile terminal 100, an audio Input/Output (I/O) port, a video Input/Output (I/O) port, an earphone port, and so on. The recognition module is implemented as a chip to store each kind of information to identify an authorization right for the mobile terminal 100, and may include a User Identity Module (UIM), a Subscriber Identity Module (SIM), a Universal Subscriber Identity Module (USIM), and so on. A device having the recognition module (hereinafter, will be referred to as ‘identification device’) may be implemented as a smart card type. Accordingly, the recognition module may be connected to the mobile terminal 100 through a port. The interface unit 170 may also be configured to receive data or power from an external device to transmit the data or power to each component inside the mobile terminal 100, or may be configured to transmit data inside the mobile terminal 100 to an external device.

Under a state that the mobile terminal 100 is connected to an external cradle, the interface unit 170 serves as a passage through which power from the external cradle is supplied to the mobile terminal 100, or a passage through which each kind of command signals input from the external cradle is transmitted to the mobile terminal 100. Each kind of command signals or power input from the cradle may also serve as signals notifying that the mobile terminal 100 is precisely mounted to the external cradle.

In addition, the controller 180 controls an overall operation of the mobile terminal 100. For instance, the controller 180 performs controls and processes relating to data communication, voice call, video call, and the like. In FIG. 1, the controller 180 includes a multimedia module 181 configured to play multimedia. The multimedia module 181 may be implemented inside the controller 180, or may be separately implemented from the controller 180. The controller 180 may also perform a pattern recognition process to recognize handwriting input or picture input on the touch screen as text or images, respectively. The power supply unit 190 may also be configured to receive external or internal power and to supply the received power to each component of the mobile terminal 100 under control of the controller 180.

In addition, the above various embodiments for the mobile terminal 100 may be implemented in a computer-readable medium using, for example, computer software, hardware, or some combination thereof. For a hardware implementation, the embodiments described above may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In some cases, such embodiments are implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in a memory (for example, the memory 160), and executed by a controller or processor (for example, the controller 180).

As shown in FIG. 1, the contents navigation module 30 is applied to the mobile terminal 100 according to an embodiment of the present invention and senses motion of the mobile terminal 100. Then, the contents navigation module 30 moves a focus on contents displayed on the mobile terminal 100 based on the sensed motion, or executes a function corresponding to a focused content. For instance, the contents navigation module 30 matches a current map matching link with a current link, and generates road guidance information based on a result of the matching. Also, the current map matching link is extracted from map data corresponding to a traveling route from a departure point to an arrival point, or a current running route without a destination.

Once motion of the mobile terminal 100 is sensed while displaying the road guidance information on the display, the contents navigation module 30 moves a focused position on the road guidance information displayed on the display, or executes a function corresponding to a focused content on the road guidance information displayed on the display. For instance, the function may be a preset function to display POI (Point of Interest) information in correspondence to motion of the mobile terminal 100. The functions of the contents navigation module 30 may be executed independently, or by the controller 180.

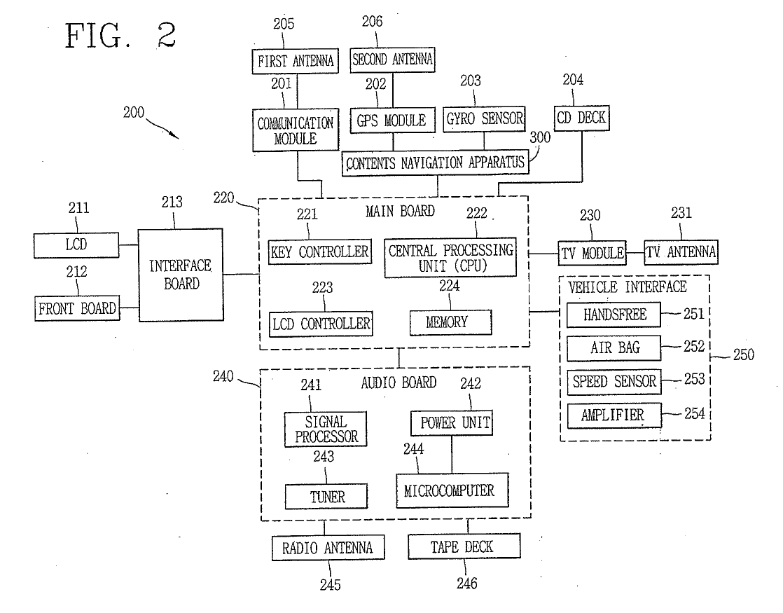

Next, a configuration of a telematics system 200 to which the contents navigation module according to an embodiment of the present invention is applied will be described in detail with reference to FIG. 2. In more detail, FIG. 2 is a block diagram showing a structure of a telematics system 200 to which a contents navigation apparatus 300 according to the present invention is applied.

Referring to FIG. 2, the telematics system 200 includes a main board 220 that includes a key controller 221 for controlling a variety of key signals, a central processing unit (CPU) 222 for executing overall controls of the telematics terminal 200, an LCD controller 223 for controlling an LCD, and a memory 224 for storing each kind of information. The memory 224 also stores map information (map data) for displaying road guidance information (vehicle guidance information) on a digital map of a display such as an LCD 211.

In addition, the memory 224 stores an algorithm for controlling traffic information collection for enabling an input of traffic information depending on a road condition in which a vehicle is currently traveling, and each kind of information for controlling the system 200 such an algorithm. Also, in FIG. 2, the main board 220 is connected to a communication module 201 provided with a uniquely given device number, and for performing voice call and data transmission/reception through a mobile communication terminal built in a vehicle, a GPS module 202 for receiving a GPS signal to guide a position of a vehicle, track a traveling path from a depart point to an arrival point, etc., and for generating current position data of a vehicle based on the received GPS signal or transmitting traffic information collected by a user as a GPS signal. Also included is a gyro sensor 203 for sensing a traveling direction of the vehicle, a CD deck 204 for reproducing a signal recorded on a compact disk (CD), and the like.

The communication module 201 and the GPS module 202 transmit/receive signals through a first antenna 205 and a second antenna 206, respectively. In addition, the main board 220 is connected to a TV module 230 that receives broadcasting signals through a broadcasting signal antenna (or TV antenna) 231. As shown in FIG. 2, the main board 220 is connected via an interface board 213 to the LCD 211 controlled by the LCD controller 223. Further, the LCD 211 processes a broadcasting signal received through the TV module 230 through predetermined processes, and then displays the processed broadcasting signal, in the form of a video signal, on the LCD 211 via the interface board 213 under control of the LCD controller 223. In addition, the LCD 211 outputs an audio signal through an amplifier 254 under control of an audio board 240 and displays each kind of video signals, or text signals based on control signals by the LCD controller 223. As discussed above, the LCD 211 may also be configured to receive an input from a user in a touch screen manner.

In addition, the main board 220 is connected via the interface board 213 to a front board 212 controlled by the key controller 221. The front board 212 is provided with buttons or keys for enabling an input of a variety of key signals so as to provide to the main board 220 a key signal corresponding to a button (or key) selected by a user. The front board 212 may also be provided with a menu key for allowing a direct input of traffic information, and the menu key may be configured to be controlled by the key controller 221. Also, the audio board 240 is connected to the main board 220 and processes a variety of audio signals. The audio board 240 may include a microcomputer 244 for controlling the audio board 240, a tuner 243 for receiving a radio signal through a radio antenna 245, a power unit 242 for supplying power to the microcomputer 244, and a signal processing unit 241 for processing a variety of voice signals.

The radio antenna 245 for receiving a radio signal and a tape deck 246 for reproducing an audio tape are also connected the audio board 240 In addition, the amplifier 254 is connected to the audio board 240 so as to output a voice signal processed by the audio board 240. Further, the amplifier 254 is connected to a vehicle interface 250. That is, the main board 220 and the audio board 240 are connected to the vehicle interface 250. A hands-free unit 251 for inputting a voice signal without the user having to use their hands to input information, an airbag 252 for a passenger's safety, a speed sensor 253 for sensing a vehicle speed, and the like are also included in the vehicle interface 250.

In addition, the speed sensor 253 calculates a vehicle speed, and provides information relating to the calculated vehicle speed to the central processing unit 222. The functions of the contents navigation apparatus 300 also include general navigation functions such as providing driving directions to a user. The contents navigation apparatus 300 applied to the telematics system 200 also senses a motion of the apparatus 300, and then moves a focus on contents displayed on the apparatus 300 based on the sensed motion, or executes a function corresponding to a focused content.

For instance, the contents navigation apparatus 300 matches a current map matching link with a current link, and generates road guidance information based on a result of the matching. As discussed above, the current map matching link is extracted from map data corresponding to a traveling route from a departure point to an arrival point, or a current traveling route without a destination. Once the motion of the navigation apparatus 300 is sensed while displaying the road guidance information on a display, the contents navigation apparatus 300 moves a focused position on the road guidance information displayed on the display, or executes a function corresponding to a focused content on the road guidance information displayed on the display.

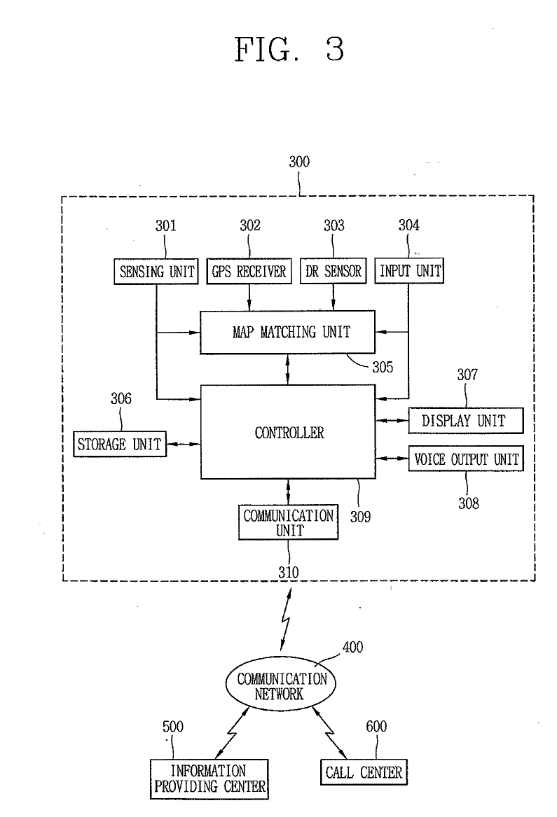

The functions of the contents navigation apparatus 300 may be executed by the contents navigation apparatus 300, or by the CPU 222 of the telematics system 200. Further, as shown in FIGS. 1 and 2, the contents navigation features according to embodiments of the present invention may be applied not only to the telematics system 200, but also to the mobile terminal 100. Next, the contents navigation apparatus will be explained in more detail with reference to FIG. 3 under an assumption that the contents navigation apparatus 300 is applied to the telematics system 200. As shown in the block diagram of FIG. 3, the contents navigation apparatus 300 includes a sensing unit 301, a GPS receiver 302, a Dead-Reckoning (DR) sensor 303, an input unit 304, a map matching unit 305, a storage unit 306, a display unit 307, a voice output unit 308, a controller 309, and a communication unit 310.

The sensing unit 301 is provided on one side surface of the contents navigation apparatus 300, and senses motion of the contents navigation apparatus 300. Further, the sensing unit 301 may be provided on an outer side surface or an inner side surface of the contents navigation apparatus 300. The sensing unit 301 senses motion of the contents navigation apparatus 300, and includes a motion recognition sensor. In addition, the motion recognition sensor includes a sensor to sense a position or motion of an object, a geomagnetism sensor, an acceleration sensor, a gyro sensor, an inertial sensor, an altimeter, and the like. Also, the motion recognition sensor may further include motion recognition-related sensors.

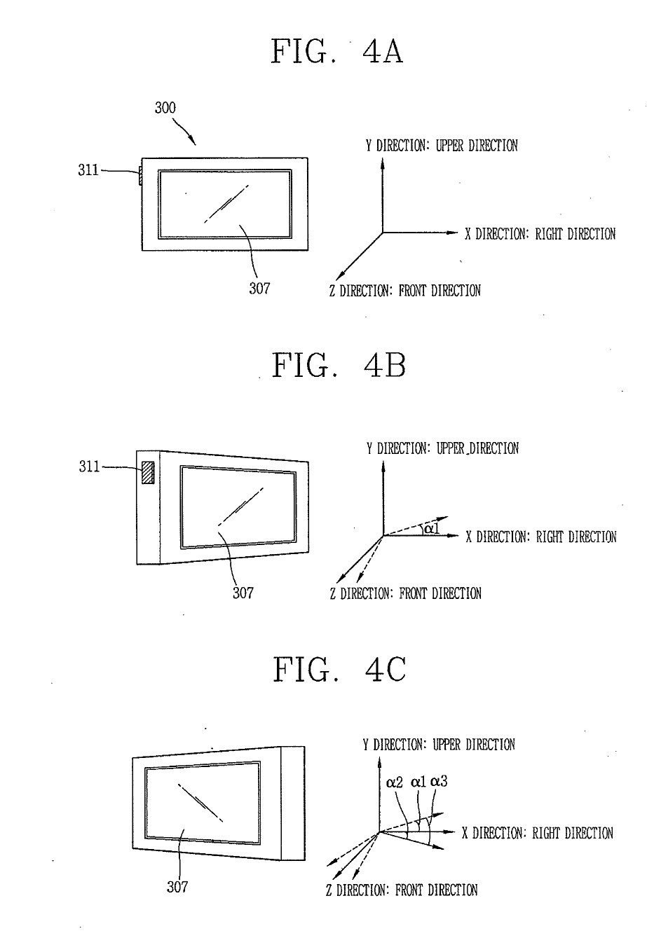

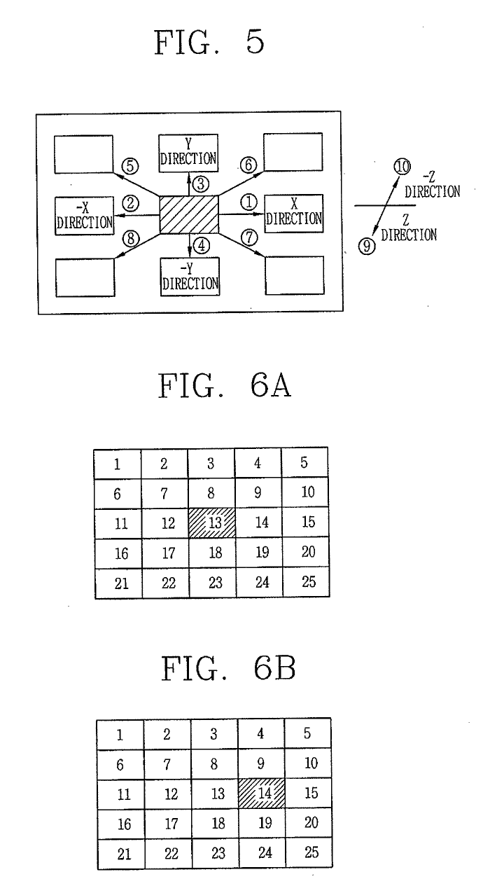

Thus, the sensing unit 301 senses the motion of the contents navigation apparatus 300, e.g., a tilt direction, a tilt angle, and/or a tilt speed of the contents navigation apparatus 300. The sensed information such as a tilt direction, a tilt angle, and/or a tilt speed is digitized through digital signal processing procedures, and then is input to the controller 309. In more detail, FIGS. 4A to 4C are front perspective views of the contents navigation apparatus 300 of FIG. 3. As shown in FIG. 4A to 4C, the contents navigation apparatus 300 includes a terminal body surrounding the display 307. Also illustrated is different directions the apparatus 300 can be moved such as an upper direction, right direction, front direction, etc. FIG. 5 illustrate different movements related to the apparatus 300

As shown in FIG. 5, the contents navigation apparatus 300 may be moved or rotated in a right direction (\textcircled{1}), a left direction (\textcircled{2}), an upper direction (\textcircled{3}), a lower direction (\textcircled{4}), a front direction (\textcircled{9}), a rear direction (\textcircled{10}), diagonal directions(\textcircled{5}\textcircled{6}\textcircled{7}\textcircled{8}), a spiral direction (not shown), and the like. The sensing unit 301 senses motion and/or rotation of the contents navigation apparatus 300. In the example shown in FIG. 5, the right direction indicates an X direction (\textcircled{1}), the left direction indicates an −X direction(\textcircled{2}), which is opposite to the +X direction, the upper direction indicates a Y direction (\textcircled{3}), the lower direction indicates a −Y direction (\textcircled{4}), which is opposite to the +Y direction, the front direction indicates a Z direction (\textcircled{9}), and the rear direction indicates a −Z direction (\textcircled{10}), which is opposite to the +Z direction. Also, the origin (reference point) for each direction corresponds to a point where the sensing unit 301 is located, or is preset by a designer. The origin may be any point inside the contents navigation apparatus 300. In one embodiment of the present invention, a center point of the contents navigation apparatus 300 is set as the origin. However, the origin is not limited to the center point.

Thus, the sensing unit 301 may sense any direction of the contents navigation apparatus 300 such as a right direction (\textcircled{1}), a left direction (\textcircled{2}), an upper direction (\textcircled{3}), a lower direction (\textcircled{4}), a front direction (\textcircled{9}), a rear direction (\textcircled{10}), diagonal direction (\textcircled{5}\textcircled{6}\textcircled{7}\textcircled{8}), a spiral direction, and the like. In addition, the GPS receiver 302 receives a GPS signal from a GPS satellite, and generates in real-time first position data of the contents navigation apparatus 300 (or the telematics system 200 or the mobile terminal 100) based on the latitude and longitude coordinates included in the received GPS signal. Then, the GPS receiver 302 outputs the generated first position data to the map matching unit 305. Also, the generated first position data is defined as the current position of the navigation apparatus 300 (or current data). The position information may be received not only through the GPS receiver 302, but also through Wi-Fi or Wibro communications.

A signal received through the GPS receiver 302 may be configured to be transmitted to the contents navigation apparatus 300 together with the position information of the mobile terminal, using the Institute of Electrical and Electronics Engineers (IEEE) 802.11 set of standards for wireless local area network (WLAN) and infrared communications, IEEE 802.15 which specializes in wireless Personal Area Network (PAN) standards including Bluetooth, Ultra-wideband(UWB), Zigbee, etc., IEEE 802.16 which is a working group on Broadband Wireless Access (BWA) Standards for the global deployment of broadband Wireless Metropolitan Area Networks (MAN), and IEEE 802.20 which is a working group on Mobile Broadband Wireless Access (MBWA) including Wireless Broadband (Wibro), World Interoperability for Microwave Access, etc.

When the contents navigation apparatus 300 is mounted to a vehicle, the DR sensor 303 measures a traveling direction and a speed of the vehicle, and generates second position data based on the measured traveling direction and speed of the vehicle. Then, the DR sensor 303 outputs the generated second position data to the map mating unit 305. Further, the technique for generating an estimated position of the contents navigation apparatus 300 included in the mobile terminal 100 or the vehicle based on the first position data generated by the GPS receiver 302 and the second position data generated by the DR sensor 303 is known, and therefore detailed explanations are omitted.

In addition, the input unit 304 is configured to receive commands or control signals through a user's button manipulations, or a user's screen manipulations in a touch or scroll manner. The input unit 304 is also configured to allow a user to select his or her desired function or input information, and may include various devices such as a keypad, a touch screen, a jog shuttle, and a microphone. Further, as shown in FIGS. 4A and 4B, the input unit 304 includes an operation button 311 disposed on one side surface of the contents navigation apparatus 300.

Also, in one embodiment, the sensing unit 301 senses the motion of the contents navigation apparatus 300 when the operation button 311 is in a pressed state. In addition, the sensing unit 301 may sense motion of the contents navigation apparatus 300 in an operable state (ON state) when the operation button 311 is pressed one time. Under this state, if the operation button 311 is re-pressed, the sensing unit 301 is in a non-operable state (OFF state). Whenever the operation button 311 is repeatedly pressed, the operational state of the sensing unit 301 can be toggled between the ON or OFF state. Also, the sensing unit 301 may sense motion of the contents navigation apparatus 300 only when the sensing unit 301 is in the ON state.

Thus, because the sensing unit 301 is turned ON or OFF by the operation button 311, the user does not inadvertently execute the sensing feature when moving the apparatus, for example. That is, the navigation apparatus 300 is prevented from executing an undesired function when the user moves the contents navigation apparatus 300. Further, when the operation button 311 is in a pressed state, the sensing unit 301 may sense the motion of the contents navigation apparatus 300 based on a time point when the operation button 311 has been pressed.

For instance, when the contents navigation apparatus 300 disposed in an initial state shown in FIG. 4A is tilted in any direction (e.g., the right direction shown in FIG. 4B) as the operation button 311 is pressed, the sensing unit 301 senses displacement due to motion of the contents navigation apparatus 300 based on a time point when the operation button 311 has been pressed (e.g., the state of FIG. 4A). Further, the displacement due to motion of the contents navigation apparatus 300 may include information or data such as a tilt direction (e.g., right direction), a tilt angle (e.g., al), and a speed the contents navigation apparatus 300 is moved.

Once the pressed state of the operation button 311 is released, the sensing unit 301 stops sensing motion of the contents navigation apparatus 300. Also, when the operation button 311 is pressed in a state of FIG. 4A or 4B, the sensing unit 301 senses displacement due to motion of the contents navigation apparatus 300 (e.g., a tilt angle of α2 or α3 in the left direction shown in FIG. 4C) based on a time point when the operation button 311 has been pressed. Once the sensing unit 301 having an operational state converted into an ON or OFF state whenever the operation button 311 is repeatedly pressed is in an ON state, the sensing unit 301 senses the motion of the contents navigation apparatus 300.

In addition, the motion of the contents navigation apparatus 300 in a temporarily stopped state starts to be sensed when the operational state of the sensing unit 301 is converted to the ON state from the OFF state as the operation button 311 is pressed. Accordingly, once the contents navigation apparatus 300 starts to move from a stopped state, the motion is sensed based on a time point that the operational state of the sensing unit 301 is converted to the ON state from the OFF state. When the contents navigation apparatus 300 which was in a stopped state for a preset time starts to move under a state that the sensing unit 301 is in an ON state, the temporarily stopped state of the contents navigation apparatus 300 serves as a reference time point.

For instance, when the contents navigation apparatus 300 is in a state shown in FIG. 4A, and when the sensing unit 301 is turned ON as the operation button 311 is pressed, the sensing unit 301 senses displacement due to the motion of the contents navigation apparatus 300 (e.g., the motion into a state shown in FIG. 4B) from the state shown in FIG. 4A. Then, if the contents navigation apparatus 300 is temporarily stopped at a state shown in FIG. 4B for a preset time, the time point when the contents navigation apparatus 300 is temporarily stopped serves as a new reference. That is, when the contents navigation apparatus 300 disposed in a tilted state as shown in FIG. 4B is stopped for a preset time, the state shown in FIG. 4B serves as a new reference. Under the tilted state shown in FIG. 4B, when the contents navigation apparatus 300 is tilted as shown in FIG. 4C, the sensing unit 301 senses displacement due to motion of the contents navigation apparatus 300 based on the new reference.

A reference time point (or reference coordinates) sensed by the sensing unit 301 may also be differently set according to an operational state of the operation button 311. However, the present invention is not limited to this. Also, an icon indicating a light emitting diode (LED), or a preset icon or an avatar may be provided at one side of the display unit 307 to indicate an ON state of the sensing unit 301 when the operation button 311 is pressed.

In addition, the map matching unit 305 generates an estimated position of a vehicle based on the first and second position data, and extracts map data corresponding to a traveling route from the storage unit 306. The map matching unit 305 also matches the estimated position of a vehicle with a link (road) included in the map data, and outputs the matched map information (map matching result) to the controller 309. In more detail, the map matching unit 305 generates an estimated position of the vehicle based on the first and second position data, and matches the estimated position of the vehicle with links of map data stored in the storage unit 306 in a link order. Then, the map matching unit 305 outputs the matched map information (map matching result) to the controller 309. The map matching unit 305 also outputs road attribution information such as a single road or a double-road included in the matched map information (map matching result) to the controller 309. The functions of the map matching unit 305 may also be implemented by the controller 309.

Further, the storage unit 306 stores map data and different types of information such as menu screens, Points Of Interest (POI) information, and function characteristic information according to a specific position of map data. The storage unit 306 also stores various User Interfaces (Uls), and Graphic User Interfaces (GUIs), displacement data due to motion of the contents navigation apparatus 300 sensed by the sensing unit 301, data and programs used to operate the contents navigation apparatus 300, etc. Also, the display unit 307 displays image information or road guidance map included in the road guidance information generated by the controller 309. As discussed above, the display unit 307 may be implemented as a touch screen. Further, the display unit 307 may display various contents such as menu screens and road guidance information using a UI and/or a GUI included in the storage unit 306. Also, the contents displayed on the display unit 307 include menu screens having various text or image data (map data or each kind of information data), icons, list menus, and combo boxes.

In addition, the voice output unit 308 outputs voice information included in the road guidance information generated by the controller 309 or a voice message with respect to the road guidance information. Also, the voice output unit 308 may be implemented as a speaker. Further, the controller 309 controls road guidance information to be generated based on the matched map information, and controls the generated road guidance information to be output to the display unit 307 and the voice output unit 308. The display unit 307 displays the road guidance information and the voice output unit 308 outputs voice information related to the road guidance information.

In addition, as shown in FIG. 3, the controller 309 controls real-time traffic information to be received from an information providing center 500 through a wire/wireless communication network 400. The received real-time traffic information is utilized when generating road guidance information. Also, the controller 309 is connected to a call center 600 through the communication unit 310, thereby allowing the user to make a phone call. The controller 309 may also control information between the contents navigation apparatus 300 and the call center 600 to be transmitted/received. In addition, the communication unit 310 may be a hands-free module having a Bluetooth function using a short-range wireless communication scheme.

The controller 309 also controls menu screens or contents displayed on the display unit 307, based on a sensed displacement due to motion of the contents navigation apparatus 300 sensed by the sensing unit 301 using the Ul and GUI. In addition, referring to FIG. 4B, when the motion of the contents navigation apparatus 300 sensed by the sensing unit 301 is tilted by α1 in the right direction, the controller 309 may control a focused position (highlighted position or activated position) on a plurality of contents or lists on menu screens displayed on the display unit 307 to be moved by one unit in the right direction, when the plurality of lists are fixed. Alternatively, when the focused position is fixed on the plurality of lists on menu screens displayed on the display unit 307 is fixed, the controller 309 may control the plurality of lists to be moved by one unit in an opposite direction to the right direction (i.e., a left direction).

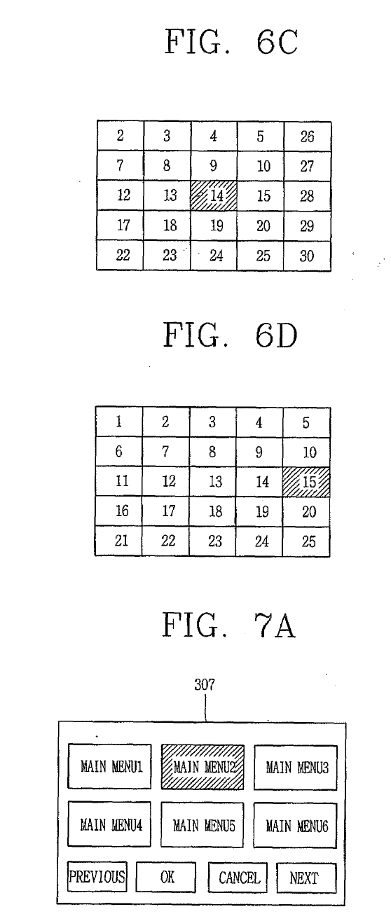

Next, referring to FIG. 6A, the sensing unit 301 is in an initial state before being operated, in which a menu ‘13’ is in a focused or highlighted (hereinafter referred to as a focused state) state. Then, when the contents navigation apparatus 300 is tilted by α1 in the right direction as the sensing unit 301 is operated, the focused position is moved by one unit in the right direction when the plurality of lists are fixed. As a result, a menu ‘14’ is in a focused state as shown in FIG. 6B. Then, when the contents navigation apparatus 300 is tilted by α1 in the right direction, the plurality of lists displayed on the display unit 307 are moved to an opposite direction to the tilted direction of the contents navigation apparatus 300 when the focused position is fixed. As a result, the menu ‘14’ is in a focused state as shown in FIG. 6C.

That is, once the motion of the contents navigation apparatus 300 is sensed, a focus on the menu screens displayed on the display unit 307 is moved by changing a focused position or activated position or by shifting a focused menu. In more detail, once the motion of the contents navigation apparatus 300 is sensed by the sensing unit 301, the controller 309 may change a focused state using a positive method to move a focus in the sensed direction by a preset unit, or a negative method to move the focus in an opposite direction to the sensed direction by a preset unit. Also, the positive or the negative method may be set by a user or manufacturer. Other methods for changing a focused state by the controller 309 are also possible.

In addition, when the contents navigation apparatus 300 having moved to the right direction maintains the tilted state for a preset first time or period, the controller 309 moves a focus on the menu screens displayed on the display unit 307 to the right direction by a preset unit (or one unit). For instance, when the contents navigation apparatus 300 is tilted by α1 in the right direction from the initial state of FIG. 6A, the focused position is moved to the right direction by one unit when the plurality of lists are fixed. As a result, the menu ‘14’ is in a focused state as shown in FIG. 6B. Under this state, when the tilted state of the contents navigation apparatus 300 in the right direction is maintained for the preset first time, the controller 309 may further move the focused position to the right direction by one unit when the plurality of lists are fixed. As a result, the menu ‘15’ is in a focused state as shown in FIG. 6D.

Also, the controller 309 may execute a function to change a focused state only when the α1 is greater than a preset first threshold value. In addition, the α1 and the first threshold value may be relative or absolute values, and comparing the al and the first threshold value with each other compares a difference value between the relative or absolute values. If the contents navigation apparatus 300 is moved or tilted within a range less than the first threshold value, the controller 309 does not execute the function to change a focused state. This feature prevents the content navigation apparatus 300 from mistakenly operating when the contents navigation apparatus 300 is minutely moved due to external vibration or a user's manipulations.

Further, referring to FIG. 4B, once the sensing unit 301 senses that the contents navigation apparatus 300 has been tilted by al in the right direction, the controller 309 may control a focus or a cursor of a mouse to be smoothly or consecutively moved in the right direction with various speeds based on the angle of al. For example, the larger an absolute value of the tilted angle is, the faster the speed of the focus is, and vice versa. That is, the moving speed of the focus may be set in proportional to the tilt angle and/or the tilt speed of the contents navigation apparatus 300. However, the present invention is not limited to this.

Also, once the sensing unit 301 senses the motion of the contents navigation apparatus 300, a focus or a cursor is moved by a preset unit or consecutively on the menu screens displayed on the display unit 307. As a result, the focus may be positioned on any content of the contents displayed on the display unit 307. In addition, when a currently focused content among the contents displayed on the display unit 307 includes upper and lower contents, the controller 309 controls the upper or lower contents to be focused based on motion of the contents navigation apparatus 300 sensed by the sensing unit 301. Further, the contents may be implemented as various menu screens such as text-based menu screens or emoticon-based menu screens.

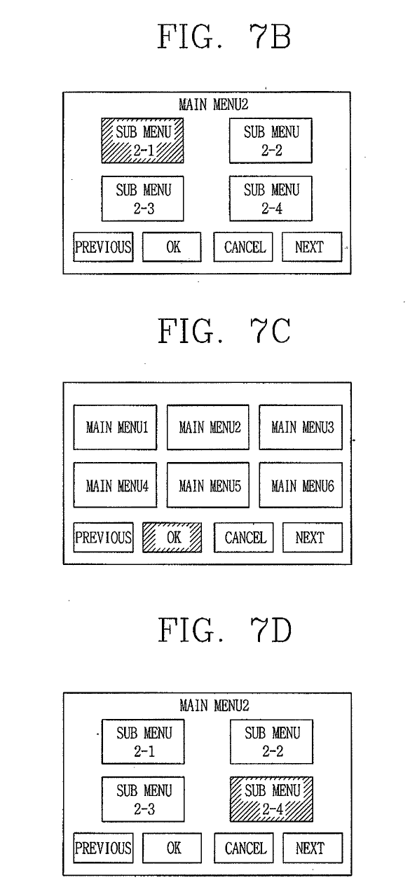

For instance, when the sensing unit 301 senses that the contents navigation apparatus 300 is shaken (moved) one time in a rear direction, the controller 309 controls the ‘sub-menu 2-1’ of FIG. 7B corresponding to a first sub-menu of the focused main menu 2 of FIG. 7A to be displayed. Under this state, if the contents navigation apparatus 300 is shaken (moved) one time in a front direction, the controller 309 displays the main menu 2 of FIG. 7A corresponding to a first upper menu of the focused sub-menu 2-1 of FIG. 7B.

That is, when the content displayed on the display unit 307 includes upper or lower content, the upper or lower content is focused based on motion of the contents navigation apparatus 300 in a front or rear direction. Also, the controller 309 may control a function of a focused content to be executed according to the motion of the contents navigation apparatus 300 in a front or rear direction. For example, as shown in FIG. 7C, when menus such as ‘NEXT’, ‘OK’, ‘CANCEL’, and ‘PREVIOUS’ are displayed on the menu screens on the display unit 307, and the motion of the contents navigation apparatus 300 in a front or rear direction is sensed by the sensing unit 301, the controller 309 executes a function corresponding to a focused (activated) menu among the displayed menus.

Under a state that each sub-menu is displayed as shown in FIG. 7B, and once the motion of the contents navigation apparatus 300 is sensed by the sensing unit 301, the controller 309 may change a focused position from the ‘sub-menu 2-1’ to ‘sub-menu 2-4’. As mentioned above in FIGS. 4 to 6, the sensing motion of the contents navigation apparatus 300 by the sensing unit 301 indicates sensing a tilt angle, a tilt speed, and the like of the contents navigation apparatus 300 in one direction among upper, lower, right, left, and diagonal directions.

The above-described embodiment of the present invention refers to the contents navigation apparatus 300 moving one time in a front or rear direction. However, the frequency (number of times) of moving the contents navigation apparatus 300 is not limited to a single time. That is, the moving of the contents navigation apparatus 300 to a lower menu by one unit may be implemented by moving the contents navigation apparatus 300 one time or two times in a rear direction. In more detail, the contents navigation apparatus 300 may be set so as to move to a lower menu by one unit when moved one time in a rear direction, whereas the contents navigation apparatus 300 may be set so as to move to an upper menu by one unit when moved two times in a rear direction. The functions of the contents navigation apparatus 300 are set according to a moving frequency in a predetermined direction by a desired frequency by a user or manufacturer of the apparatus. When a moving frequency of the contents navigation apparatus 300 in a predetermined direction is sensed by the sensing unit 301, the controller 309 executes a function corresponding to the sensed moving frequency.

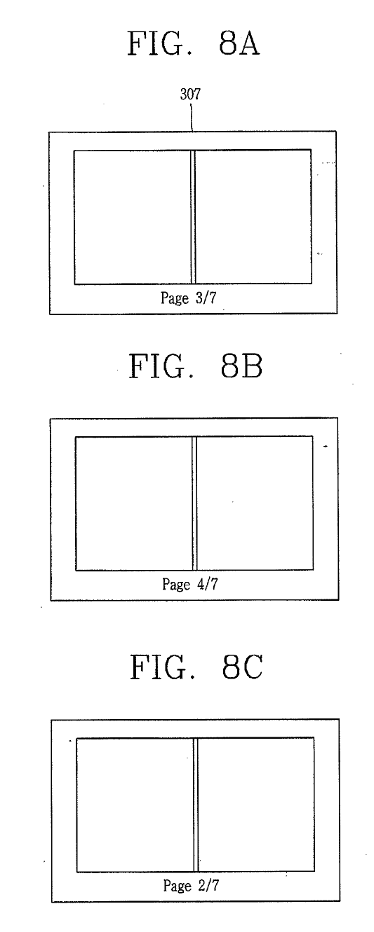

Further, when the sensing unit 301 senses that the contents navigation apparatus 300 has been tilted with an angle larger than a preset threshold value in one direction among preset directions (e.g., left or right direction), the controller 309 controls the previous or next screen of a current screen among a plurality of sequential screens or contents to be automatically focused based on the tilt direction. For instance, when the sensing unit 301 senses that the contents navigation apparatus 300 has been tilted with an angle larger than a preset threshold value in one direction (e.g., a left or right direction), the controller 309 controls the previous screen (page 2 of FIG. 8C) or the next screen (page 4 of FIG. 8B) of a current screen (page 3 of FIG. 8A) among a plurality of sequential screens to be automatically focused. In addition, the controller 309 may provide effects like turning a page using the UI and/or the GUI stored in the storage unit 306 when changing a focused position from the current screen to the next or previous screen.

In addition, when the sensing unit 301 senses that the contents navigation apparatus 300 has been tilted with an angle larger than a preset threshold value in one direction among preset directions (e.g., a left or right direction), the controller 309 controls a function of a focused content among contents displayed on the display unit 307 to be executed based on the tilt direction. As mentioned previously, when the sensing unit 301 senses that the contents navigation apparatus 300 has been tilted with an angle smaller than a preset threshold value, the controller 309 may move a focus from the current menu to other menu as shown in FIG. 7D.

For instance, when the sensing unit 301 senses that the contents navigation apparatus 300 has been tilted with an angle larger than a preset threshold value in a right direction instantaneously (or for a time within a predetermined time) in a state of FIG. 7B, the controller 309 executes a preset control function based on the tilt direction. That is, when the contents navigation apparatus 300 is instantaneously tilted in a right direction with an angle larger than a preset threshold value, the controller 309 displays a first upper menu of the currently focused sub-menu 2-1 of FIG. 7B, i.e., the main menu 2 of FIG. 7A. Alternatively, when the sensing unit 301 senses that the contents navigation apparatus 300 has been tilted with an angle smaller than a preset threshold value in a right direction in a state of FIG. 7B, the controller 309 executes a preset control function based on the tilt direction. That is, when the contents navigation apparatus 300 is tilted in a right direction with an angle equal to or smaller than a preset threshold value, the controller 309 controls a focus to be moved from the current sub-menu 2-1 of FIG. 7B to ‘sub-menu 2-1’ of FIG. 7D.

Also, some or all of the components of the contents navigation apparatus 300 mentioned in FIG. 3 such as the sensing unit 301, the GPS receiver 302, the DR sensor 303, the input unit 304, the map matching unit 305, the storage unit 306, the display unit 307, the voice output unit 308, the controller 309, and the communication unit 310 may be substituted by other components of the mobile terminal 100 having similar functions. For example, the sensing unit 301 of the contents navigation apparatus 300 may be substituted by the sensing unit 140 of the mobile terminal 100, the GPS receiver 302 may be substituted by the position location module 115, the DR sensor 303 may be substituted by the sensing unit 140, the input unit 304 may be substituted by the user input unit 130, the storage unit 306 may be substituted by the memory 160, the display unit 307 may be substituted by the display 151, the voice output unit 308 may be substituted by the audio output module 152, the communication unit 310 may be substituted by the wireless communication unit 110, and the map matching unit 305 and the controller 309 may be substituted by the controller 180. Also, the map matching unit 305 and the controller 309 may be implemented as one module in the mobile terminal 100.

Similarly, some or all of the components of the contents navigation apparatus 300 mentioned in FIG. 3 such as the GPS receiver 302, the DR sensor 303, the map matching unit 305, the storage unit 306, the display unit 307, the voice output unit 308, the controller 309, and the communication unit 310 may be substituted by other components of the telematics system 200 having similar functions. For example, the GPS receiver 302 of the contents navigation apparatus 300 may be substituted by the GPS module 202 of the telematics system 200, the DR sensor 303 may be substituted by the gyro sensor 203, the storage unit 306 may be substituted by the memory 224, the display unit 307 may be substituted by the LCD 211, the voice output unit 308 may be substituted by the amplifier 254, the communication unit 310 may be substituted by the communication module 201, and the map matching unit 305 and the controller 309 may be substituted by the CPU 222.

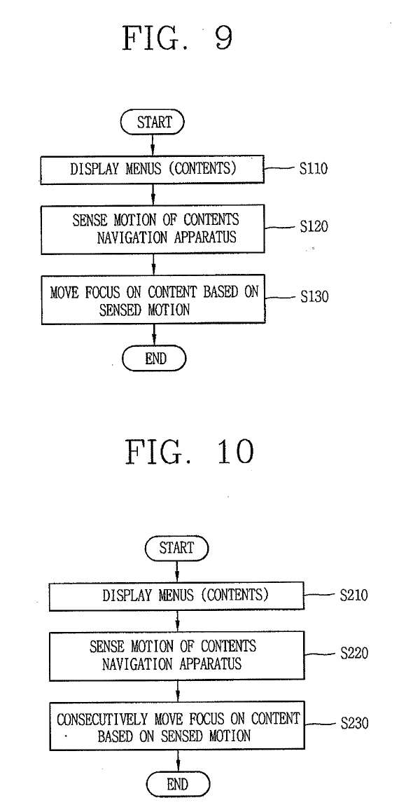

Next, FIG. 9 is a flowchart showing a contents navigation method according to a first embodiment of the present invention. FIG. 3 will also be referred to throughout the description of the different embodiments. As shown in FIG. 9, the controller 309 displays one of various menus or contents on the display unit 307 using a GUI and/or Ul stored in the storage unit 306 (S110). The contents may include menus or menu screens, map data or road guidance information, icons, avatars, patterns, symbols, menus or icons overlapping on the map data, data generated by coupling between the respective data (e.g., menus, map data, icons, avatars, patterns, symbols, etc.), and all other displayable types of data.

Then, with reference to FIG. 5, the sensing unit 301 senses the motion and/or rotation of the contents navigation apparatus 300 in a right direction (\textcircled{1}), a left direction (\textcircled{2}), an upper direction (\textcircled{3}), a lower direction (\textcircled{4}), a front direction (\textcircled{9}), a rear direction (\textcircled{10}), diagonal directions (\textcircled{5}\textcircled{6}\textcircled{7}\textcircled{8}), a spiral direction, and the like (S120). The sensing unit 301 also senses the motion or displacement due to the motion of the contents navigation apparatus 300 including a tilt angle and a tilt speed in one of the directions. In addition, as discussed above, the sensing unit 301 senses the motion of the contents navigation apparatus 300 when the sensing unit 301 is turned ON via the operation button 311.

Then, the controller 309 changes a focused state on the display unit 307 based on the sensed motion of the contents navigation apparatus 300 (S130). For example, and with reference to FIG. 6A, when the menu ‘13’ among menus displayed on the display unit 307 is focused or highlighted, and the sensing unit 301 senses that the contents navigation apparatus 300 has been tilted in a right direction, the controller 309 changes the focused state from the menu ‘13’ to the menu ‘14’ as shown in FIG. 6B. Thus, the focus is moved from the current menu to another menu based on the sensed motion of the contents navigation apparatus 300.

Next, FIG. 10 is a flowchart showing a contents navigation method according to a second embodiment of the present invention. Steps S210 and S220 in FIG. 10 are similar to the steps S110 and S120 in FIG. 9. That is, the controller 309 displays one of various menus or contents on the display unit 307 according to the GUI and/or the UI stored in the storage unit 306 (S210). The contents may include menus or menu screens, map data or road guidance information, icons, avatars, patterns, symbols, menus or icons overlapping on the map data, data generated by coupling between the respective data (e.g., menus, map data, icons, avatars, patterns, symbols, etc.), and other displayable all types of data.

Then, the sensing unit 301 senses the motion of the contents navigation apparatus 300 including a moved and/or rotated direction, a tilt angle, and a tilt speed in the moved and/or rotated direction. When the sensing unit 301 is turned ON via the operation button 311, the sensing unit 301 senses the motion of the contents navigation apparatus 300 (S220). The controller 309 then smoothly moves or consecutively moves a focus or specific icon such as an arrow on the display unit 307 based on the sensed motion of the contents navigation apparatus 300 including information such as a tilt direction, a tilt angle, and a tilt speed. That is, in this embodiment, the controller 309 moves a focus or a cursor of a mouse on the display unit 307 in the sensed direction with a speed proportional to the tilt angle (S230).

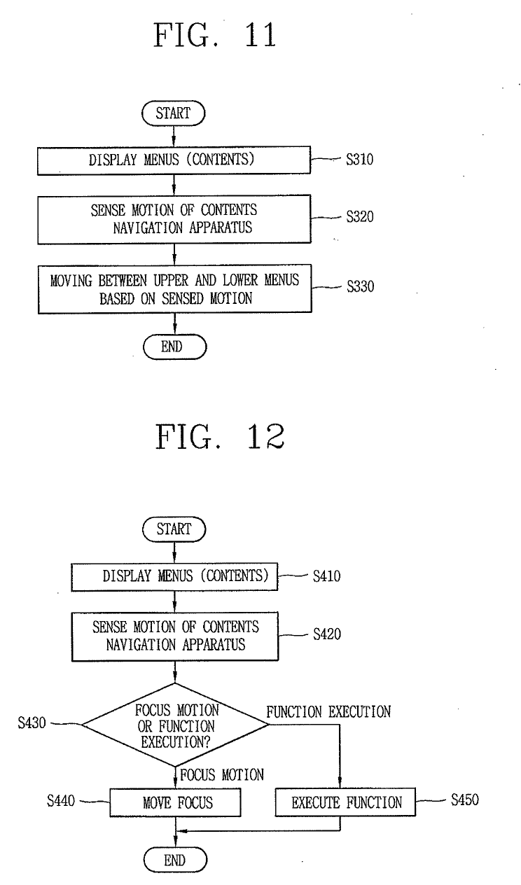

Next, FIG. 11 is a flowchart showing a contents navigation method according to a third embodiment of the present invention. Steps S310 and S320 are also similar to the steps S110 and S120 in FIG. 9 (and the corresponding steps in FIG. 10). Accordingly, a detailed description of steps S310 and S320 will be omitted. Further, in this embodiment, the controller 309 moves between upper and lower menus displayed on the display unit 307 based on the sensed motion of the contents navigation apparatus 300 (S330).

In more detail and referring to FIG. 7A, when the ‘main menu 2’ is a focused menu on the display unit 307, and when the sensing unit 301 senses that the contents navigation apparatus 300 is moved one time in a rear direction, the controller 309 displays the ‘sub-menu 2-1’ shown in FIG. 7B corresponding to a first sub-menu of the focused ‘main menu 2’ shown in FIG. 7A. In addition, under this state, if the contents navigation apparatus 300 is moved (e.g., shaken) one time in a front direction, the controller 309 displays the ‘main menu 2’ in FIG. 7A corresponding to a first upper menu of the focused ‘sub-menu 2-1’ in FIG. 7B. Thus, when a currently focused content among the contents displayed on the display unit 307 includes upper and lower contents, the controller 309 controls the focused position to be changed from the current content to the upper or lower contents by a preset unit, based on the motion of the contents navigation apparatus 300 in a front or rear direction by a preset frequency.

Next, FIG. 12 is a flowchart showing a contents navigation method according to a fourth embodiment of the present invention. Again, steps S410 and S420 are also similar to the steps S110 and S120 in FIG. 9 (and the corresponding steps in FIGS. 10 and 11). Accordingly, a detailed description of steps S410 and S420 will be omitted. However, in this embodiment, the controller 309 then determines whether the sensed motion of the contents navigation apparatus 300 indicates changing a focused position or indicates executing a focused menu (S430).

In addition, the controller 309 performs the determination process so as to determine whether the contents navigation apparatus 300 has been tilted in one direction among upper, lower, right, left, and diagonal directions or has been moved in back and forth directions. The controller 309 also determines whether there is a menu on a currently focused position. Therefore, if the contents navigation apparatus 300 has been tilted by any angle in one direction among upper, lower, right, left, and diagonal directions, the controller 309 moves a currently focused position by one unit or by a preset unit in the tilted direction.

Then, if there is not a menu on a currently focused position, the currently focused position is consecutively changed in the tilted direction in proportion to the tilt angle and/or speed (S440). Further, if the contents navigation apparatus 300 has been moved in back and forth directions, a preset function corresponding to the moving direction (e.g., moving to upper/lower menus, moving to previous/next menus, or OK/cancel) is executed. Also, if there is a menu on a currently focused position, the controller 309 executes a function corresponding to the currently focused menu (S450).

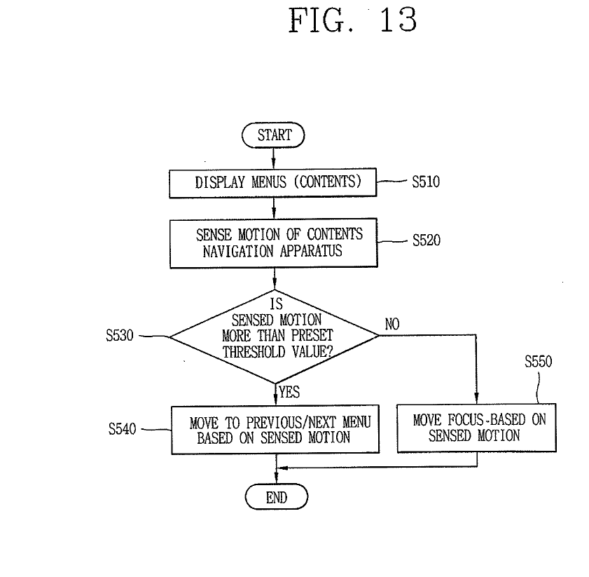

Next, FIG. 13 is a flowchart showing a contents navigation method according to a fifth embodiment of the present invention. Again, steps S510 and S520 are also similar to the steps S110 and S120 in FIG. 9 (and the corresponding steps in FIGS. 10-12). Accordingly, a detailed description of steps S510 and S520 will be omitted. However, in this embodiment, the controller 309 determines whether a tilt angle of the contents navigation apparatus 300 is larger than a preset threshold value (S530). The tilt angle and the preset threshold value may be relative or absolute values, and it is assumed that comparing the tilt angle and the preset threshold value with each other is to compare absolute values with each other. However, the present invention is not limited to this.

As a result of the determination, if the tilt angle is larger than the preset threshold value (Yes in S530), the currently focused position is moved on a plurality of screens displayed on the display unit 307 in a sequential manner to the next or previous screen in correspondence to the tilted direction by a preset unit. Accordingly, the focused next or previous screen is displayed on the display unit 307. Similarly, if the tilt angle is larger than the preset threshold value and the currently focused menu includes upper or lower menus, the currently focused position may be changed to the upper or lower menus in correspondence to the tilted direction by a preset unit. Accordingly, the focused upper or lower menu may be displayed on the display unit 307. However, if the tilt angle is equal to or smaller than the preset threshold value (No in S530), a focus on the currently activated menu is moved in the tilted direction by a preset unit (S550).

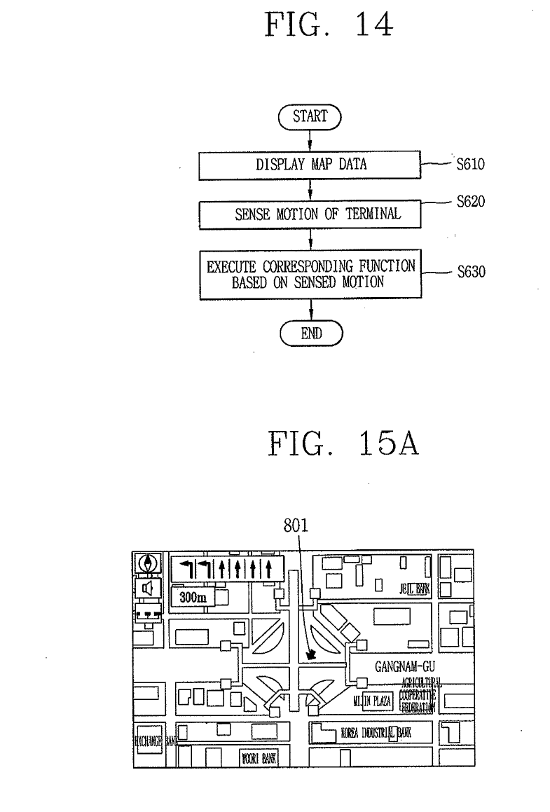

FIG. 14 is a flowchart showing a contents navigation method according to a sixth embodiment of the present invention. In this embodiment, the controller 309 displays map data (S610) and then senses the motion of the apparatus 300 (S620). That is, the map matching unit 305 generates first position data and/or second position data based on signals received through the GPS receiver 302 and/or the DR sensor 303, and generates an estimated position of a vehicle based on the first position data and/or the second position data. Then, the map matching unit 305 extracts map data corresponding to a traveling route from the storage unit 306. Also, the traveling route may be a traveling route from a departure point to an arrival point or a traveling route without a destination.

The map matching unit 305 also matches the estimated position of a vehicle with a link (road) included in the map data, and outputs the matched map information (map matching result) to the controller 309. That is, the map matching unit 305 generates an estimated position of a vehicle based on the first and second position data, and matches the estimated position of a vehicle with links of map data stored in the storage unit 306 in a link order. Then, the map matching unit 305 outputs the matched map information (map matching result) to the controller 309.

The controller 309 controls road guidance information to be generated based on the matched map information, and controls the generated road guidance information to be output to the display unit 307 and the voice output unit 308. Then, in step S620, the sensing unit 301 senses the motion of the apparatus 300 (S620). That is, and as discussed above with respect to FIG. 5, the sensing unit 301 may sense any directions of the contents navigation apparatus 300 such as a right direction (\textcircled{1}), a left direction (\textcircled{2}), an upper direction (\textcircled{3}), a lower direction (\textcircled{4}), a front direction (\textcircled{9}), a rear direction (\textcircled{10}), diagonal directions (\textcircled{5}\textcircled{6}\textcircled{7}\textcircled{8}), and a spiral direction, motion with a circle drawing and the like, and a tilt angle and a tilt speed in one of the above directions (S620).

Then, based on the sensed motion of the contents navigation apparatus 300, a function corresponding to the motion is applied to map data displayed on the display unit 307 (S630). That is, when the sensed motion of the contents navigation apparatus 300 corresponds to a motion in upper, lower, right, left, diagonal, and spiral directions, a focus on the map data is moved to the corresponding direction. Further, when the tilt angle in the corresponding direction is larger than or equal to the previous angle, i.e., when the current displacement is larger than or equal to the previous displacement, the controller 309 consecutively moves a focus to the corresponding direction. However, when the tilt angle in the corresponding direction is smaller than the previous angle, i.e., when the current displacement is larger than or equal to the previous displacement, a focus on the map data is stopped.

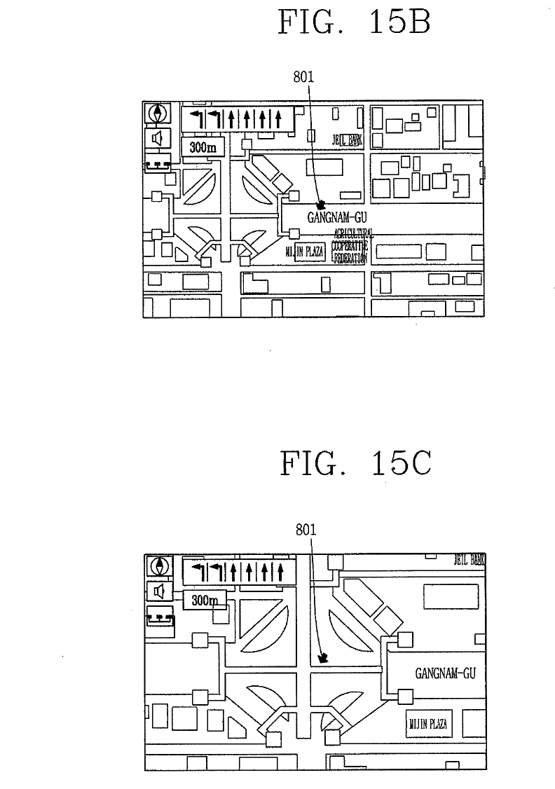

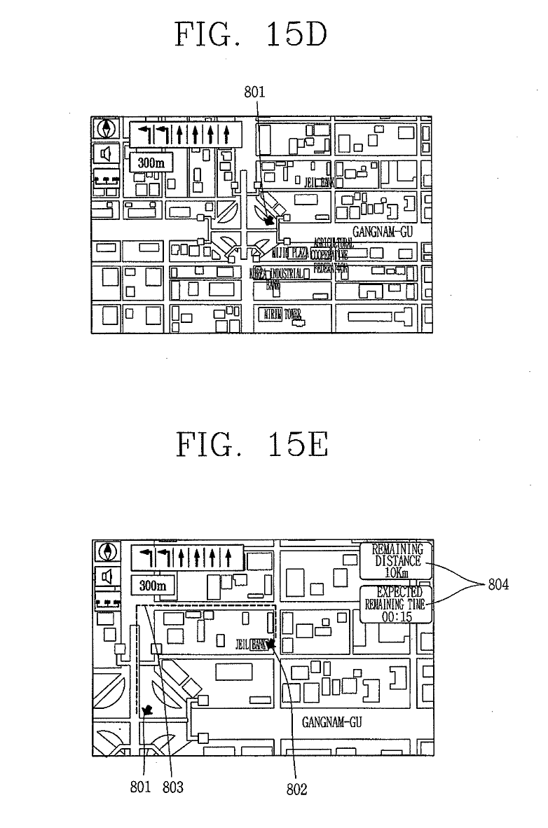

In more detail, and as shown in FIG. 15A, when the sensing unit 301 senses that the contents navigation apparatus 300 has been tilted in any direction (e.g., a right direction), when a focused position 801 on the map data is fixed to the center, the map data is moved to an opposite direction to the tilted direction as shown in FIG. 15B. Accordingly, the moved map data is displayed on the display unit 307, which utilizes the same technical features as those of FIG. 6C.

When the sensing unit 301 senses that the contents navigation apparatus 300 has moved in back and forth directions, a preset function (e.g., function to enlarge or contract the map data) is executed in correspondence to the back and forth directions. In more detail, and with reference to FIG. 15A, when the sensing unit 301 senses that the contents navigation apparatus 300 has moved to one of back and forth directions, the map data is displayed with an enlarged state (FIG. 15C) or a contracted state (FIG. 15D) based on the center of a screen (or a position of a focus 801) displayed on the display unit 307.

In the related art, the map data is displayed on regions of the display unit 307 rather than regions where execution buttons such as motion, enlargement, and contraction are displayed, or the map data is displayed with execution buttons such as motion, enlargement, and contraction overlapped thereon. However, in an embodiment of the present invention, execution buttons such as motion, enlargement, and contraction need not be displayed on the display unit 307. Accordingly, the map data can be displayed on an entire region of the display unit 307, thereby providing a larger size of the map data to a user, and preventing unnecessary display of the execution buttons.

That is, the functions to move or enlarge/contract the map data displayed on the display unit 307 may be executed through simple manipulations of the contents navigation apparatus 300. Also, when the sensed motion of the contents navigation apparatus 300 corresponds to a preset motion, e.g., clockwise drawing of a circle, or counterclockwise drawing of a circle, or positioning a front surface of the contents navigation apparatus 300 towards a center of the Earth, a preset function corresponding to the preset motion, or a preset shortened menu function may be executed.

For instance, when the sensing unit 301 senses that motion of the contents navigation apparatus 300 corresponds to a counterclockwise drawing of a circle, the controller 309 executes one function preset in correspondence to the counterclockwise drawing of a circle, e.g., moving to an upper menu, OK, moving to the previous menu, and enlargement. On the contrary, when the sensing unit 301 senses that motion of the contents navigation apparatus 300 corresponds to clockwise drawing of a circle, the controller 309 executes one function preset in correspondence to the clockwise drawing of a circle, e.g., moving to a lower menu, cancellation, moving to the next menu, and contraction.

Further, the preset function corresponding to the clockwise or counterclockwise drawing of a circle may be a shortened menu function. For instance, when the sensing unit 301 senses that motion of the contents navigation apparatus 300 corresponds to counterclockwise drawing of a circle, the controller 309 executes a preset shortened menu function corresponding to the counterclockwise drawing of a circle, i.e., generates a route from the current position displayed on the display unit 307 to a preset specific destination such as home or office thereby to display the route on the display unit 307.

When the sensing unit 301 senses that a rotated state of the contents navigation apparatus 300 by 180° from an initial state (a state that the front surface of the display unit 307 is towards a first direction), i.e., a state that a front surface of the display unit 307 is towards a second direction opposite to the first direction, or an overturned state of the contents navigation apparatus 300 (a state that the front surface of the display unit 307 is towards a center of the Earth) is maintained for a preset time, the controller 309 turns OFF the mobile terminal 100 or the telematics system 200 to which the contents navigation apparatus 300 has been applied.

Also, once Points of Interest (POI) of map data displayed on the display unit 307 or a preset motion of the contents navigation apparatus 300 on any road are sensed by the sensing unit 301, the controller 309 may display detailed information about the corresponding road or the POI having a focus positioned thereon on the display unit 307. In addition, the sensing unit 301 may be provided with a text recognition module to recognize motion of the contents navigation apparatus 300 sensed by the sensing unit 301 and to execute a function corresponding to the sensed motion.

For instance, once finished sensing motion of the contents navigation apparatus 300, the sensing unit 301 converts the sensed motion into a text. Then, the controller 309 controls a function (e.g., an enlargement function) corresponding to the converted text to be executed. When the sensing unit 301 senses that motion of the contents navigation apparatus 300 corresponds to a preset motion, the controller may control a preset function corresponding to the preset motion, i.e. any shortened menu function, to be executed.

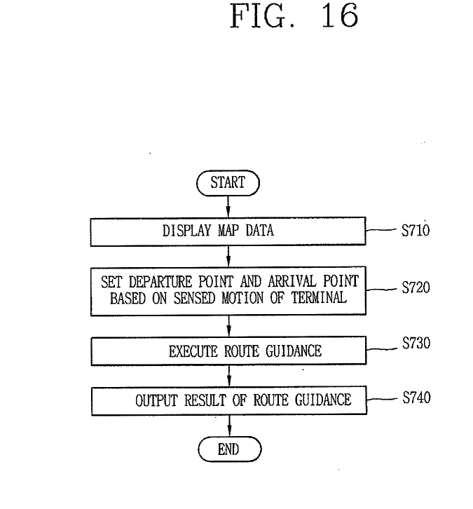

Next, FIG. 16 is a flowchart showing a route search method using a contents navigation method according to an eighth embodiment of the present invention. Step S710 in FIG. 16 is similar to the step S610 in FIG. 14. That is, the map matching unit 305 generates first position data and/or second position data based on signals received through the GPS receiver 302 and/or the DR sensor 303, and generates an estimated position of a vehicle based on the first position data and/or the second position data. Then, the map matching unit 305 extracts map data corresponding to a traveling route from the storage unit 306. Further, the traveling route may be a traveling route from a departure point to an arrival point, or a traveling route without a destination.

The map matching unit 305 also matches the estimated position of a vehicle with a link (road) included in the map data, and outputs the matched map information (map matching result) to the controller 309. In more detail, the map matching unit 305 generates an estimated position of a vehicle based on the first and second position data, and matches the estimated position of a vehicle with links of map data stored in the storage unit 306 in a link order. Then, the map matching unit 305 outputs the matched map information (map matching result) to the controller 309. The controller 309 generates road guidance information based on the matched map information, and controls the generated road guidance information to be output to the display unit 307 and the voice output unit 308.

Then, as shown in FIG. 15A, a position of a focus is moved to any first point. Once the sensing unit 301 senses that the contents navigation apparatus 300 has moved to any direction by a preset frequency (e.g., motion of two times), the first point 801 where the focus is located is set as a departure point for route search (route guidance or, path search). Then, as shown in FIG. 15E, the focus is moved to any second point 802 by moving the contents navigation apparatus 300. Once the sensing unit 301 senses that the contents navigation apparatus 300 has moved to any direction by a preset frequency, the second point 802 where the focus is located is set as an arrival point (S720).

Then, a route search is started based on the set departure point 801 and the arrival point 802. The route search is executed based on preset user's information, road conditions using TPEG information, current status information of a vehicle (e.g., oil status, tire pressure status, etc.) (S730). Then, a result of the route search, e.g., a route 803 shown in FIG. 15E is output through the display unit 307 and the voice output unit 308. Based on the route 803, information 804 such as a distance between the departure point 801 and the arrival point 802 and expected time may be displayed on the display unit 307. Further, the arrival point 802 may be selected as a user clicks a desired point in a touch screen manner (S740).

As mentioned above, the contents displayed on the display can be easily manipulated by moving a focus or by executing a currently focused menu based on a sensed motion of the contents navigation apparatus. Also, in the contents navigation apparatus and corresponding method according to embodiments of the present invention, contents are manipulated according to motion of the contents navigation apparatus.

In addition, in the contents navigation apparatus and corresponding method according to embodiments of the present invention, contents may be displayed on the display with enlarged sizes, and an entire region of the display may be efficiently utilized as the number of execution buttons on the display is reduced. Further, contents displayed on the display can be easily manipulated by moving a focus or by executing a currently focused menu based on a sensed motion of the contents navigation apparatus. Accordingly, contents can be easily manipulated, and mis-sensing of the sensor unit can be prevented, or mal-operation of the contents navigation apparatus. Further, according to embodiments of the present invention, a function to move map data (or contents), or a function to enlarge/contract a screen is executed based on motion of the contents navigation apparatus. Accordingly, the contents navigation apparatus can be easily manipulated.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A contents navigation method, comprising:
displaying contents on a display screen of a navigation apparatus;
sensing, via a sensing unit, a motion of the navigation apparatus;
receiving an input signal configured to turn on and off the sensing unit; and
controlling, via a controller, the displayed contents according to the sensed motion of the navigation apparatus by the sensing unit when the received input signal turns on the sensing unit.

2. The method of claim 1, wherein the displayed contents comprise at least one of menu screens, map data, icons, avatars, patterns, and symbols.

3. The method of claim 1, wherein the sensed motion of the terminal corresponds to at least one of a first tilt direction, a first tilt angle, and a first tilt speed.

4. The method of claim 3, wherein the controlling step further comprises:
moving a focus on the displayed contents by a preset unit based on the sensed first tilt direction.

5. The method of claim 4, wherein the controlling step further comprises:
controlling a moving speed of the focus in proportion to at least one of the sensed first tilt angle and first tilt speed.

6. The method of claim 1, wherein the controlling step further comprises:
executing a function corresponding to a focused content based on the sensed motion of the terminal.

7. The method of claim 6, wherein the function comprises at least one of a function to move to next or previous contents, an OK function, a cancellation function, a function to execute a preset operation, a function to move to upper and lower contents corresponding to the focused content, and an enlargement/contract function of the focused contents.

8. The method of claim 6, wherein the executing step executes the function corresponding to the focused content when the sensing unit senses the navigation apparatus is moved by a preset frequency in a preset direction, said function including a preset function that is executed correspondence to the preset direction and the preset frequency.

9. The method of claim 6, wherein the executing step further comprises:
controlling the displaying step to display Point Of Interest (POI) information about the focused point or road-related information based on the sensed motion of the navigation apparatus.

10. The method of claim 1, wherein the displayed contents include a map, and
wherein the controlling step further comprises:
setting a first point where a focus point on the displayed is located as a departure point when the sensing step senses the navigation apparatus is moved by a first preset frequency in a first preset direction;
moving the focus according to the sensed motion of the navigation apparatus;
setting a second point to which the focus point has moved as an arrival point when the sensing step senses the navigation apparatus is moved by a second preset frequency in a second preset direction;
executing a route search function based on of the departure point and the arrival point; and
controlling the displaying step to display a result of the route search executing step.

11. The method of claim 1, wherein the controlling step further comprises:
moving a focus on the displayed contents by a preset unit in a second direction opposite to a first direction sensed by the sensing step.

12. A navigation apparatus, comprising:
a display unit configured to display contents on a display screen of a navigation apparatus;
a sensing unit configured to sense a motion of the navigation apparatus;
an input unit configured to receive an input signal configured to turn on and off the sensing unit; and
a controller configured to control the displayed contents according to the sensed motion of the navigation apparatus by the sensing unit when the received input signal turns on the sensing unit.

13. The navigation apparatus of claim 12, wherein the displayed contents comprise at least one of menu screens, map data, icons, avatars, patterns, and symbols.

14. The navigation apparatus of claim 12, wherein the sensed motion of the terminal corresponds to at least one of a first tilt direction, a first tilt angle, and a first tilt speed.

15. The navigation apparatus of claim 14, wherein the controller is further configured to move a focus on the displayed contents by a preset unit based on the sensed first tilt direction.

16. The navigation apparatus of claim 15, wherein the controller is further configured to control a moving speed of the focus in proportion to at least one of the sensed first tilt angle and first tilt speed.

17. The navigation apparatus of claim 12, wherein the controller is further configured to execute a function corresponding to a focused content based on the sensed motion of the terminal.

18. The navigation apparatus of claim 17, wherein the function comprises at least one of a function to move to next or previous contents, an OK function, a cancellation function, a function to execute a preset operation, a function to move to upper and lower contents corresponding to the focused content, and an enlargement/contract function of the focused contents.

19. The navigation apparatus of claim 17, wherein the controller is further configured to execute the function corresponding to the focused content when the sensing unit senses the navigation apparatus is moved by a preset frequency in a preset direction, said function including a preset function that is executed correspondence to the preset direction and the preset frequency.

20. The navigation apparatus of claim 17, wherein the controller is further configured to control the display unit to display Point Of Interest (POI) information about the focused point or road-related information based on the sensed motion of the navigation apparatus.

21. The navigation apparatus of claim 12, wherein the displayed contents include a map, and
wherein the controller is further configured to set a first point where a focus point on the displayed is located as a departure point when the sensing step senses the navigation apparatus is moved by a first preset frequency in a first preset direction, to move the focus according to the sensed motion of the navigation apparatus, to set a second point to which the focus point has moved as an arrival point when the sensing step senses the navigation apparatus is moved by a second preset frequency in a second preset direction, to execute a route search function based on of the departure point and the arrival point, and to control the display unit to display a result of the route search executing step.

22. The navigation apparatus of claim 12, wherein the controller is further configured to move a focus on the displayed contents by a preset unit in a second direction opposite to a first direction sensed by the sensing unit.
